(19) United States
(12) Patent Application Publication
(10) Pub. No.: US 2007/0007932 A1
(43) Pub. Date: Jan. 11, 2007

(54) DC Duel Isolated Bias Return Power Reclaimation System

(75) Inventor: Lawrence Alger Cronce, Stevens Point, WI (US)

Correspondence Address: Mr.Lawrence Alger Cronce, 5139 Hwy 66, Stevens Point, WI, 54481, US

(73) Assignees: NANOSECOND TECHNOLOGIES INCORPORATED, Stevens Point, WI (US); PEICOSECOND TECHNOLOGIES CORPORATION, Stevens Point, WI (US)

(21) Appl. No.: 11/162,235

(22) Filed: Sep. 2, 2005

Related U.S. Application Data
(60) Provisional application No. 60/595,438, filed on Jul. 5, 2005.

(51) Int. Cl. G05F 1/10

(52) U.S. Cl. 323/234

(57) ABSTRACT

This is an system to reclaim DC power unused by an load, so that the load is allowed to use nearly 100% of the DC power, making it better than AC for power reclaimation.

In examining the discharging of batteries, I discovered that in normal usage not only is there an loss of bias from each side of the battery, but in fact there is an acceptance of the opposite polarities into each bias, in which 1 00% of the unused power is going into discharging the batteries. Unused positive bias is going into discharging the negative plates, and Unused negative bias is going into discharging the positive plates.

The DC Duel Isolated Bias Return Power Reclaimation System effectively solves this problem allowing up to 100% of the power that is Unused by the load to be reused. Now, the design is to take DC power supply of any type and put an storage capacitor between the two polarities. Then connect an switching regulator and increase the voltage positive and negative feeding this into an second DC storage capacitor. Then depending on the type of DC power source, battery or electrochemical reactor core and DC standard electrical wiring source, you would either have TWO matched loads on the two biases for an battery, or only ONE load on one bias for the other two types of DC sources.

The concept with the two matched loads on two biases for an battery source is take four coils two on either side of the positive bias load connecting the two coils, one to the high voltage positive capacitor side and one to the lower voltage positive capacitor side through the two coils. The same thing is done on the negative side with an load matching the power usage of the positive load. On all other DC power sources, you can have an load on just one bias, shorting out the capacitor plates of high and low one bias, and putting an load between two coils on the higher voltage and lower voltage of the two same bias capacitor plates. Note that you can use matched loads on both biases for any type of DC power source.

This system allows you to use ultra high efficiency loads such as DC motors and reclaim close to 100% of the unused power and use it again. In some cases this means that loads can go up to 100 times further on the same amount of power.

Note, voltage can be increased or decreased from the base power supply capacitively or inductively to make the differential necessary for power reclamation. However, doing so inductively and increasing the voltage is the most efficient.

What is claimed is:

1. What I claim as my invention is Reclaiming unused power in DC for single load designs, using higher and lower same bias voltage.

2. What I claim as my invention is Reclaiming unused power in DC for duel matched load designs using same bias higher and lower voltage on each of the two biases.

3. What I claim as my invention is increasing or decreasing voltage inductively or capacitively for the purpose of DC power reclamation.
